(19) United States
(12) Patent Application Publication
(10) Pub. No.: US 2008/0002718 A1
(43) Pub. Date: Jan. 3, 2008

(54) Method and apparatus to restore default settings in an Optical Network Terminal (ONT)

(76) Inventors: Marc R. Bernard, Miramar, FL (US); Nirav J. Modi, Elmhurst, IL (US); Mark D. Mueller, Naperville, IL (US); John A. Stock, Leesburg, VA (US); Douglas F. Ortega, Potomac, MD (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/479,128

(22) Filed: Jun. 30, 2006

(51) Int. Cl. H04L 12/56

(52) U.S. Cl. 370/395.51

(57) ABSTRACT

A method and apparatus to restore default settings in an Optical Network Terminal (ONT) prevents the ONT from retaining previous ONT settings after the ONT is removed from a network. One example embodiment notifies a management system that an ONT is removed from the network and updates settings of the ONT with default settings via an Optical Line Terminal (OLT) in operative communication with the management system. The default settings disable at least one service, such as voice, data, or video service, between the OLT and ONT. Through use of the example embodiment, ONTs can be properly deleted from a network prior to or after removal from the network, which simplifies redeployment of ONTs and control over the ONTs.

### BACKGROUND OF THE INVENTION

An Optical Network Terminal (ONT) is equipped with non-volatile memory that retains ONT operating parameters in case the ONT reboots, loses power, is deleted from a network database, or is removed from a Passive Optical Network (PON). Examples of ONT operating parameters requiring non-volatile memory include parameters for ATM Adaptation Layer Type 1 (AAL1)/Session Initiation Protocol (SIP) mode, Ground Start/Loop Start mode, and video administrator state.

There are scenarios, however, when it is undesirable to maintain the current operating parameters in non-volatile memory. In one example scenario, a person may physically move an ONT without authorization and connect it to the same or a different PON. As a result, a recipient of the ONT can receive communications services, such as data or video, without paying for it because the ONT operating parameters are retained in non-volatile memory. In another example scenario, a technician may remove the ONT from a subscriber's premises and restock it in inventory. When the ONT is redeployed in the field, however, the retained operating parameters introduce additional variables and unknowns that make troubleshooting the ONT more difficult.

### SUMMARY OF THE INVENTION

A method and corresponding apparatus to restore default settings in an Optical Network Terminal (ONT) in accordance with an embodiment of the present invention is provided. The example embodiment includes: (1) notifying a management system that an ONT is removed from a network, and (2) updating settings of the ONT with default settings via an Optical Line Terminal (OLT) in operative communication with the management system. The default settings may disable at least one service between the OLT and the ONT.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a Passive Optical Network (PON) employing an example embodiment of the present invention;

FIG. 2A is a flow diagram illustrating an example embodiment of the present invention;

FIG. 2B is a network block diagram of exemplary elements of a PON in accordance with example embodiments of the present invention;

FIG. 3 is a network block diagram of exemplary elements of a PON configured to delete an Optical Network Terminal (ONT) in accordance with example embodiments of the present invention;

FIGS. 4 and 5 are network block diagrams of exemplary elements of a PON configured to address a situation in which an ONT is removed from a network without being properly deleted in accordance with example embodiments of the present invention;

FIG. 6 is an example flow diagram illustrating an embodiment of the present invention in which an ONT updates it own settings for communications;

FIG. 7 is an example flow diagram illustrating how an optical communications system may address a situation in which an ONT is removed from a network without being properly deleted according to an embodiment of the present invention;

FIG. 8 is an example flow diagram illustrating a manner by which an ONT may be properly deleted from a PON according to an embodiment of the present invention; and

FIG. 9 is another example flow diagram illustrating how an optical communications system may address a situation in which an ONT is removed from a network without being properly deleted according to an embodiment of the present invention.

### DETAILED DESCRIPTION OF THE INVENTION

A description of example embodiments of the invention follows.

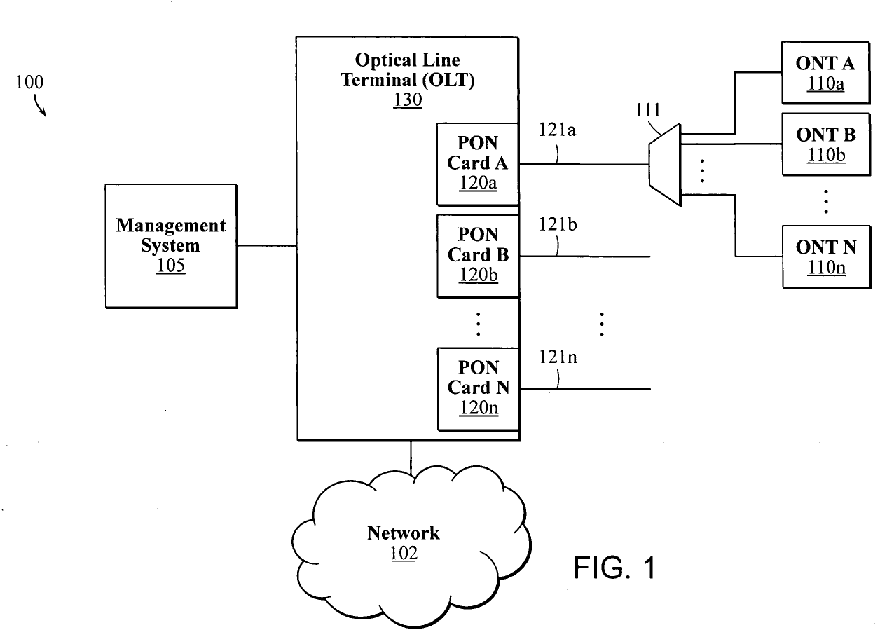

FIG. 1 is a network diagram of an exemplary Passive Optical Network (PON) 100. The PON 100 may include a management system 105, Optical Line Terminal (OLT) 130, optical splitter 111, and multiple Optical Network Terminals (ONTs) 110a-n. The OLT 130 includes multiple PON cards 120a-n which provide respective optical feeds 121a-n to optical splitters (e.g., optical splitter 111). An optical feed 121a, for example, is distributed through the optical splitter 111 to the ONTs 110a-n to provide communications services between the OLT 130 and the ONTs 110a-n. The management system 105 communicates with the OLT 130 to manage functions of the OLT 130 and, in some embodiments, the PON cards 120a-n or ONTs 110a-n. The OLT 130, in turn, may communicate with other OLTs or network devices (not shown) in or connected to a network 102, such as a Wide Area Network (WAN).

The PON 100 may be deployed for fiber-to-the-business (FTTB), fiber-to-the-curb (FTTC), or fiber-to-the-home (FTTH) applications. The optical feeds 121a-n in the PON 100 may operate at bandwidths such as 155 Mb/sec, 622 Mb/sec, 1.25 Gb/sec, 2.5 Gb/sec, or any other desired bandwidth implementations. The PON 100 may incorporate Asynchronous Transfer Mode (ATM) communications, broadband services such as Ethernet access and video distribution, Ethernet point-to-multipoint topologies, and native communications of data and Time Division Multiplex (TDM) formats.

Each ONT 110a-n in the example network 100 is a multi-service terminal providing Internet, voice, data, video, or other services to a subscriber's premises. The OLT 130 may have knowledge of each ONT 110a-n based on a serial number or other identifier associated with each respective ONT 110a-n. After the OLT 130 ranges a given ONT (e.g., ONT 110a) to learn and correct for optical signal power, distance, timing delays, and other parameters, the OLT 130 provisions the given ONT 110a with several attributes enabling communications services between the OLT 130 and the given ONT 110a. Many of these attributes or settings are maintained in non-volatile memory so that after an ONT is upgraded and rebooted, the attributes or settings are retained, thereby eliminating relearning the attributes through repeating the ranging.

The ONTs 110a-n store settings or operating parameters in ONT memory (not shown) to enable one or more of the communications services between the OLT 130 and the ONTs 110a-n. The ONT settings include: (i) settings that enable or disable (a) video or data services or (b) certain characteristics of video or data services between the ONTs 110a-n and the OLT 130; (ii) settings that enable or disable Plain Old Telephone System (POTS) services or certain characteristics of the POTS services (e.g., Loop Start versus Ground Start); and (iii) an Emergency-Stop setting (also known as the G.983.1 (or G.984.3) PLOAM command: Disable_SerialNumber=ON/OFF). Some ONT settings (e.g., video service settings) are stored in non-volatile memory for the purpose of retaining these settings, for example, across ONT reboots after software upgrades. In certain scenarios, however, it is useful for the ONT to discard the ONT settings. Several scenarios involve physically removing or disconnecting an ONT from the PON 100. For example, an authorized person, such as a technician, may remove an ONT and place it in inventory. But, when the ONT is redeployed, it may behave unexpectedly because of the previous settings retained by the ONT. In another example, an unauthorized person may remove an ONT from the PON 100, connect it to the same or a different PON, and receive communications services without paying for them because the retained settings enable such communications services.

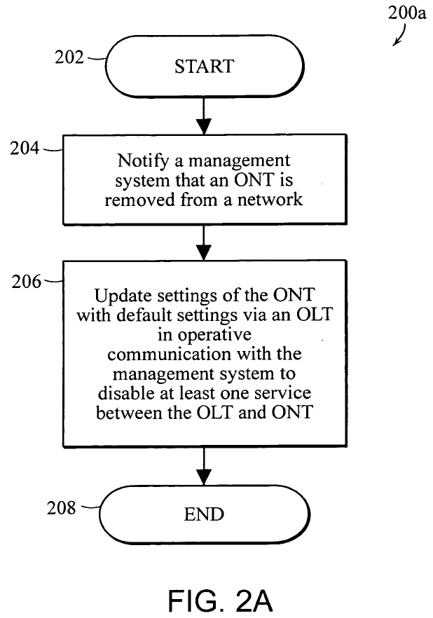

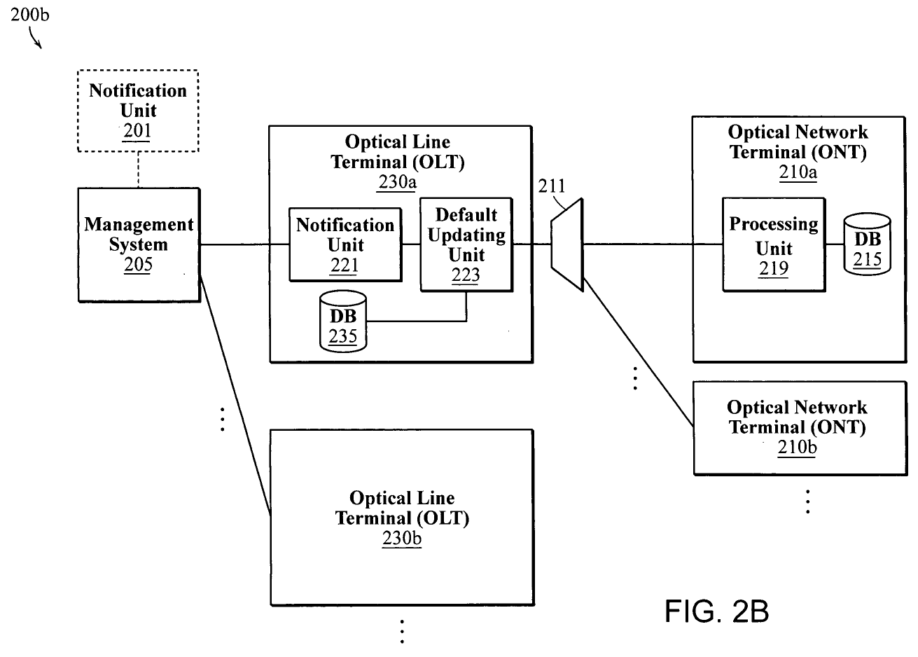

FIG. 2A is a flow diagram 200a illustrating an example embodiment of the present invention that resolves the problems described above by updating the settings retained by an ONT with default settings. After starting (202), a management system is notified (204) that an ONT is removed from a network, such as a PON. The settings of the ONT are then updated (206) with default settings, via an OLT in operative communication with the management system, to disable at least one service between the OLT and ONT before ending (208).

The default settings, such as manufacturing default settings, may disable one or more communications services between the OLT and the ONT. The ONT settings that are updated may include ONT settings stored in non-volatile memory or all ONT settings. Thus, once the ONT settings are updated with the default settings, an unauthorized person who removes the ONT and connects it elsewhere cannot receive communications services without paying for them (or otherwise adhering to a contractual or other arrangement with a service provider) because the default settings disable the communications services. Moreover, by resetting the ONT with the default settings, the ONT behaves as expected by a technician because the ONT operates based on the default settings and not settings retained by the ONT that are unknown to the technician. This minimizes troubleshooting efforts required by technicians in the field who redeploy ONTs.

FIG. 2B is a network block diagram of exemplary elements of a PON 200b in accordance with example embodiments of the present invention. The PON 200b includes one or more ONTs 210a, 210b, and so forth, that are connected to and receive communications services from an OLT 230a via an optical splitter 211. The PON 200b may also include other OLTs (e.g., OLT 230b) supporting other ONTs (not shown) with communications services.

The OLT 230a may include an OLT database 235, which stores default settings of the ONTs 210a, 210b, and so forth, that itself is stored in non-volatile memory, such as RAM, ROM, CD-ROM, and so forth. The OLT 230a also includes a notification unit 221 in communication with a management system 205. The notification unit 221 notifies the management system 205 that a given ONT (e.g., ONT 210a) is removed from a network, such as the PON 200b. A default updating unit 223, in communication with and responsive to the notification unit 221, updates settings of the given ONT 210a with default settings, such as the default settings contained in the OLT database 235, via the OLT 230a to disable at least one service between the OLT 230a and the given ONT 210a.

In other example embodiments, the notification unit 201 may notify the management system 205 that the given ONT 210a is removed or deleted from the network. For example, a user, such as a network operator or technician, may notify or send a command to the management system 205, via the notification unit 201, to delete the given ONT 210a. The management system 205, in turn, notifies the OLT 230a that the given ONT 210a is removed or deleted from the PON 200b. The OLT 230a, in turn, may cause the given ONT 210a or an ONT processing unit 219 to update the given ONT 210a with default settings contained in an ONT database 215.

In general, embodiments of the present invention may address at least two example scenarios surrounding the removal of an ONT from a PON. In a first example scenario, a management system, OLT, or PON card residing in the OLT may delete or modify an ONT record at the PON card, OLT, or management system prior to removal of the ONT from the PON. In the second example scenario, the ONT may be removed from the PON without being properly deleted. An ONT may be removed from a PON by physically removing or disconnecting the ONT from the PON. It may further include changing ONT settings or interrupting communications between the OLT and the PON effectively to remove the ONT from the PON. For example, an OLT may change or update ONT settings to disable all communications services, premium communications services, subset(s) of communications services, and so forth, between the OLT and the ONT.

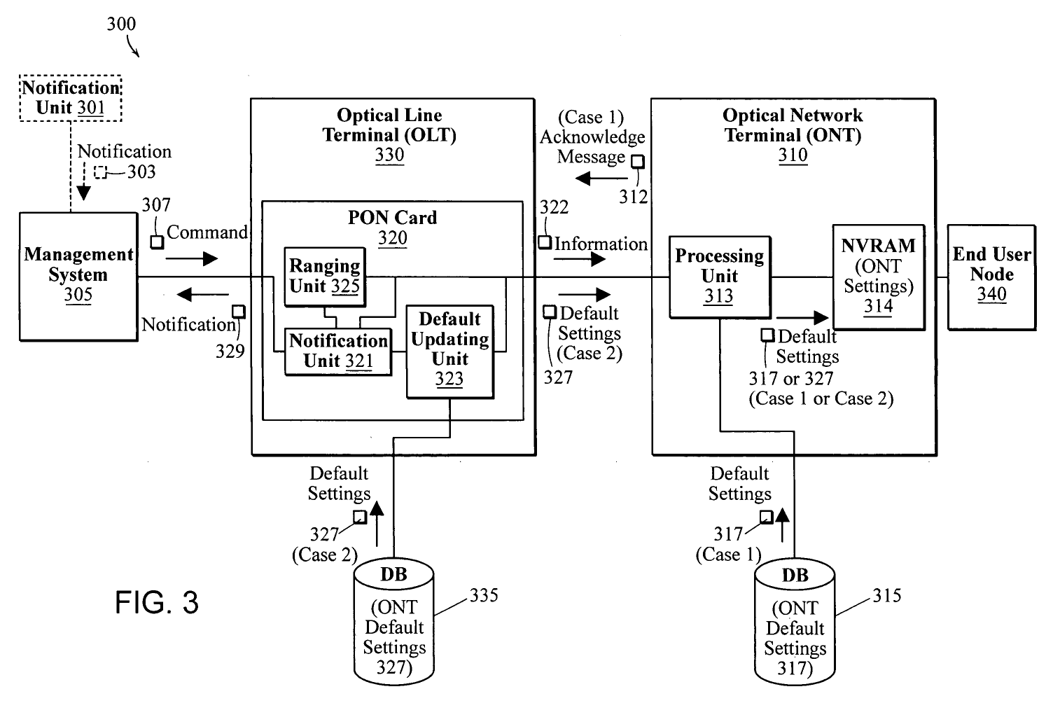

FIG. 3 is a network block diagram of exemplary elements of a PON 300 configured to address the first scenario described immediately above in which an ONT 310 is properly deleted from the PON 300 before being removed. A notification unit 301 may send a notification message 303 to a management system 305 to notify the management system 305 that the ONT 310 is deleted from a network, such as the PON 300. The notification message 303 may be a message from a user (e.g., service provider operator) requesting that the management system 305 delete the ONT 310 from the management system's records or requesting that the management system 305 disable one or more communications services between the OLT 330 and the ONT 310. The notification message 303 may also be a message in the form of a Transaction Language 1 (TL1) command or some other communications interface that different management interfaces (not shown) understand. The management system 305 may then notify the OLT 330 or a PON card 320 that the ONT 310 is removed or deleted from the PON 300 by sending, for example, a command packet 307 requesting that the OLT 330 or a PON card 320 remove or delete the ONT 310.

In one embodiment (case 1), the PON card 320 may include a default updating unit 323 that sends information, such as information message(s) or packet(s) 322, to the ONT 310 in response to receipt of the command packet 307. The information cause(s) the ONT 310 or the processing unit 313 of the ONT 310 to access an ONT database 315 containing ONT default settings 317 and to update ONT settings contained in memory or non-volatile memory, such as non-volatile random access memory (NVRAM) 314, with the default settings 317. The ONT default settings 317 may disable one or more communications services between the OLT 330 and the ONT 310 being provided to an end user node 340. In this embodiment, an end user does not interact directly with the ONT 310; the end user interacts indirectly with the ONT 310 via the end user node 340. In other embodiments, however, the end user may interact directly with the ONT in the same way that an end user interacts with a cable set top box or a broadband home router. After the ONT settings in the NVRAM 314 are updated with the default settings 317, the ONT 310 may send a message, such as an acknowledge message 312, indicating that the settings of the ONT 310 have been successfully updated with the default settings 317.

Once the PON card 320 accepts the message from the ONT 310 indicating that the ONT settings have been updated with the default settings 317, a PON notification unit 321 may send notification packet(s) 327 to the management system 305 to notify it that the ONT 310 has been properly deleted from the PON 300.

In another embodiment (case 2), the default updating unit 323 of the PON card 320 accesses a database 335 containing default settings 327 for ONT 310 upon receiving the command packet 307 from the management system 305. The OLT 330 or PON card 320 may maintain the database 335 of ONT default settings. The PON card 320 or OLT 330 may alternatively download a configuration file that contains the ONT default settings for the ONT 310 and other ONTs. In other embodiments, the PON card 320 or OLT 330 may hardcode the default settings in software.

The default updating unit 323 then provisions the ONT 310 or the NVRAM 314 with the default settings 327, for example, via the processing unit 313. The PON card 320 may use ONT Management and Control Interface (OMCI) channels, which are standard communication channels between the OLT 330 and the ONT 310, to provision the ONT 310 with the default settings 327. In provisioning the ONT 310 with default settings, the PON card 320 may send one message or multiple messages for each individual ONT default setting or attribute. The default settings 327 may include manufacturing default settings when the ONT 310 first came out of the factory.

As with the case 1 embodiment, the notification unit 321 may send a notification message 329 to the management system indicating that the ONT 310 has been successfully deleted from the PON 300. The notification unit 321 or other element of the PON card 320 may be in operative communication with a ranging unit 325. The ranging unit 325 may discontinue ranging the ONT 310 in response to the notification unit 321 notifying it that the ONT 310 is removed from a network (e.g., PON 300). The PON card, 320 may then delete an ONT record corresponding to the ONT 310.

Elements of the PON 300 in the embodiments described above may be configured to perform the functions described above to assist in areas such as network management housekeeping, inventory management, or future customer installation with ONTs that were previously deployed in the network.

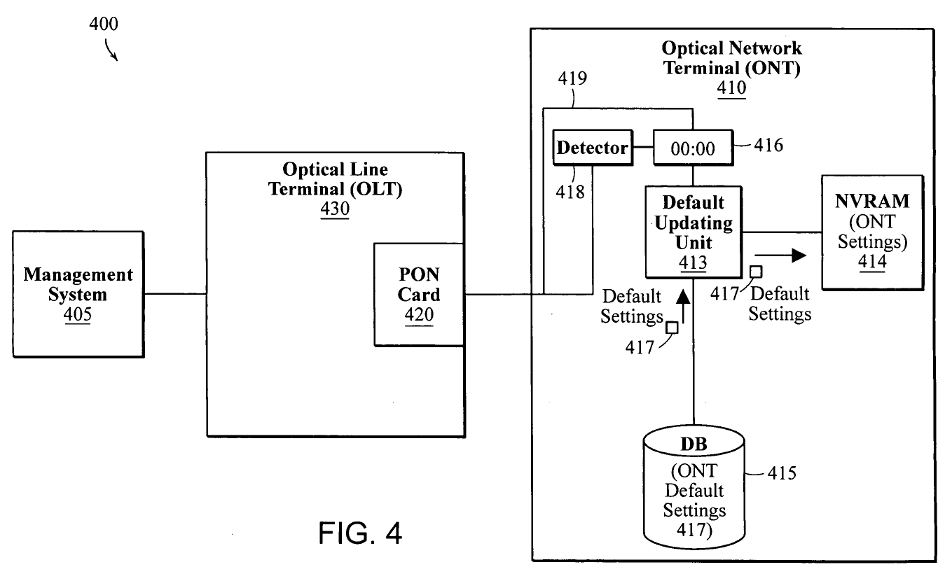

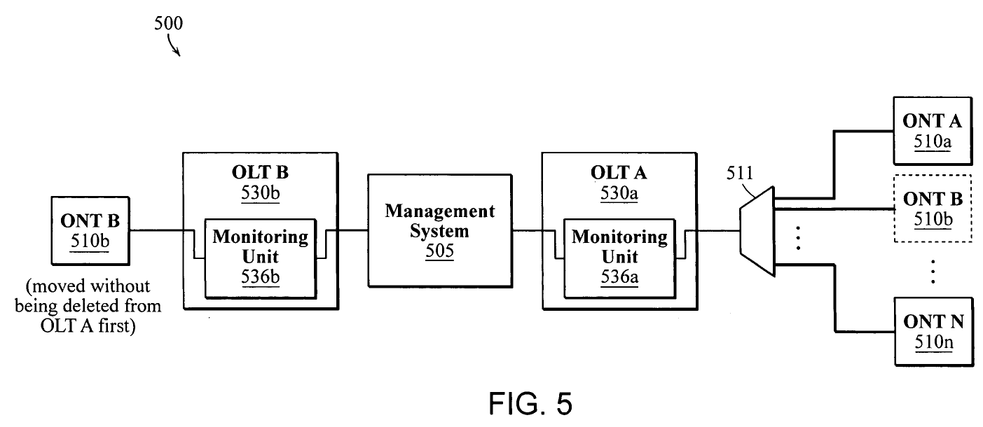

FIG. 4 and FIG. 5 are network block diagrams of exemplary elements of PON 400 and PON 500, respectively, configured to address the second scenario in which ONTs 410, 510b are removed from respective PONs 400, 500 without being properly deleted.

In the example embodiment shown in FIG. 4, the ONT 410 connects through a PON card 420 to an OLT 430. A management system 405 manages these elements of the PON 400. In one embodiment, the ONT 410 includes a timing mechanism 416, such as a digital timer. The timing mechanism 416 connects to a detector 418 that detects whether the ONT 410 has been disconnected from the PON 400 or communications between the OLT 430 and the ONT 410 have been otherwise interrupted. When the detector 418 detects that the ONT 410 has been removed from the PON card 420 or the PON 400, the detector 418 starts the timing mechanism 416.

If the ONT is subsequently powered up and does not become ranged by the OLT 430 within a time period defined by the timing mechanism 416, a default updating unit 413 accesses a database 415 of ONT default settings 417 and updates the ONT settings in NVRAM 414 with the ONT default settings 417. The default settings may disable one or more communications services between the OLT 430 and the ONT 410. The length of time defined in the timing mechanism 416 may be configurable by the OLT 430 or the PON card 420 via a communications line 419. The length of time may be configured to be long enough to allow a technician to remove the ONT 410 and perform maintenance or other troubleshooting activities. Thus, the above elements of the ONT 410 are configured to ensure, for example, that an unauthorized person who removes an ONT is prevented from connecting the ONT 410 to a different PON card (not shown) or to a different port (not shown) of the same PON card 420 and have access to unauthorized communications services.

For example, a homeowner may remove an ONT from her premises and give it to her neighbor or a thief may remove an ONT from a person's premises. The neighbor or thief, in turn, may connect the ONT to a different PON card or to a different port of the same PON card in an attempt to access video services without authorization from a service provider. An ONT according to embodiments of the present invention, however, prevents such activity.

In the example embodiment shown in FIG. 5, the PON 500 includes a management system 505 connected to multiple OLTs 530a, 530b (OLT A and OLT B). Each OLT 530a, 530b includes respective monitoring units 536a, 536b. The monitoring units 536a, 536b are in operative communication with the management system 505. Each OLT 530a, 530b, in turn, connects to one or more ONTs. For example, OLT A 530a connects to multiple ONTs 510a-n through an optical splitter 511.

The OLT A monitoring unit 536a is configured to detect when an ONT is removed from the PON 500 without being properly deleted. After the OLT A monitoring unit 536a detects that ONT B 510b is removed from the PON 500, a notification unit (not shown) in communication with the OLT A monitoring unit 536a may notify the management system 505 that the ONT B 510b is removed from the PON 500 without being properly deleted. The monitoring units 536a, 536b then monitor for a presence of ONT B 510b at a different OLT (OLT B 530b) or different port at the same OLT (OLT A 530a). After a monitoring unit 536b in OLT B 530b detects the presence of ONT B 510b, a default updating unit (not shown) at OLT B 530b updates the settings of ONT B 510b with default settings to disable at least one service between ONT B 510b and OLT B 530b. In another scenario, the monitoring unit 536a at OLT A 530a may detect a presence of ONT B 510b at a different port of OLT A 530a. In this instance, OLT A 530a includes a default updating unit (not shown) that updates the settings of ONT B 510b with default settings to disable at least one service between ONT B 510b and the different port of OLT A 530a

The monitoring units 536a, 536b may provide information directly to the management system 505 before, simultaneously with, or after causing the ONT B 510b to update its settings with default settings. Further, the OLTs 530a, 530b, after detecting at monitoring units 536a, 536b the removal of an ONT (e.g., ONT B 510b), may maintain a report of this information. This allows a service provider to know of those ONTs that have or have not been properly deleted. These reports may be used by other people in inventory management to ensure that ONTs that might have a problem can be dealt with in-house instead of being redeployed to the customer to give the new customer problems with an ONT.

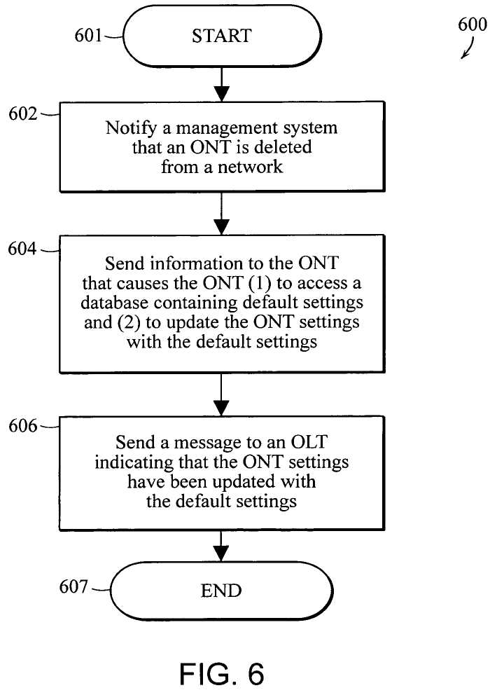

FIG. 6 is an example flow diagram 600 illustrating an embodiment of the present invention in which an ONT updates its own settings for communications. Subsequent to starting (601), a management system is notified (602) that an ONT is deleted from the optical communications network. This may include (i) a user deleting a record corresponding to an ONT or a monitoring unit at an OLT or (ii) a notification unit at the OLT indicating to the management system that an ONT is deleted from the optical communications network. Next, information is sent (604) to the ONT that causes the ONT (1) to access a database containing default settings and (2) to update the ONT settings with the default settings. A message is sent (606) to an OLT or a PON card on the OLT indicating that the OLT settings have been updated with the default settings before the flow diagram ends (607).

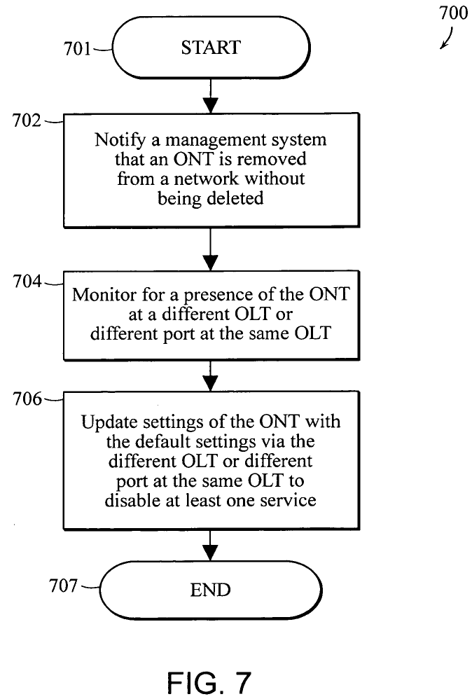

FIG. 7 is an example flow diagram 700 illustrating how an optical communications system may address a situation in which an ONT is removed from a network without being properly deleted. After starting (701), a management system is notified (702) that an ONT is removed from a network without being deleted. Next, a presence of the ONT at a different OLT or a different port at the same OLT is monitored (704). In response to detecting the presence of the ONT at the different OLT or the different port at the same OLT, the settings of the ONT are updated (706) with the default settings via the different OLT or the different port at the same OLT prior to ending (707). The default settings disable one or more services between the ONT and the different OLT or the different port at the same OLT.

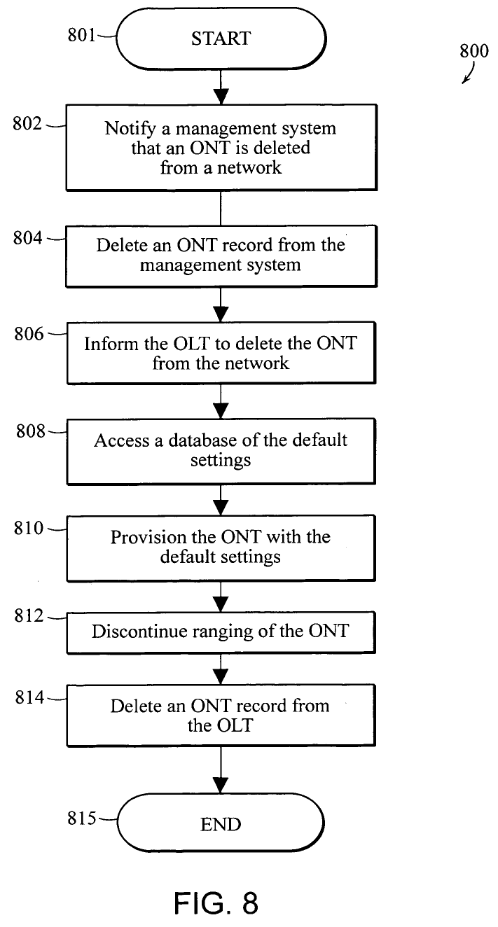

FIG. 8 is an example flow diagram 800 illustrating a manner by which an ONT is properly deleted from a PON. After starting (801), a management system is notified (802) that an ONT is deleted from a network. For example, a user, such as a network operator, may notify or send a command to the management system to delete or modify an ONT record corresponding to the ONT. Next, the ONT record is deleted (804) from the management system. The management system then informs (806) an OLT to delete the ONT, corresponding to the ONT record, from the PON. The OLT may access (808) a database of default settings and provision (810) the ONT with the default settings. The OLT discontinues ranging (812) the ONT and deletes (814) an ONT record corresponding to the ONT before ending (815).

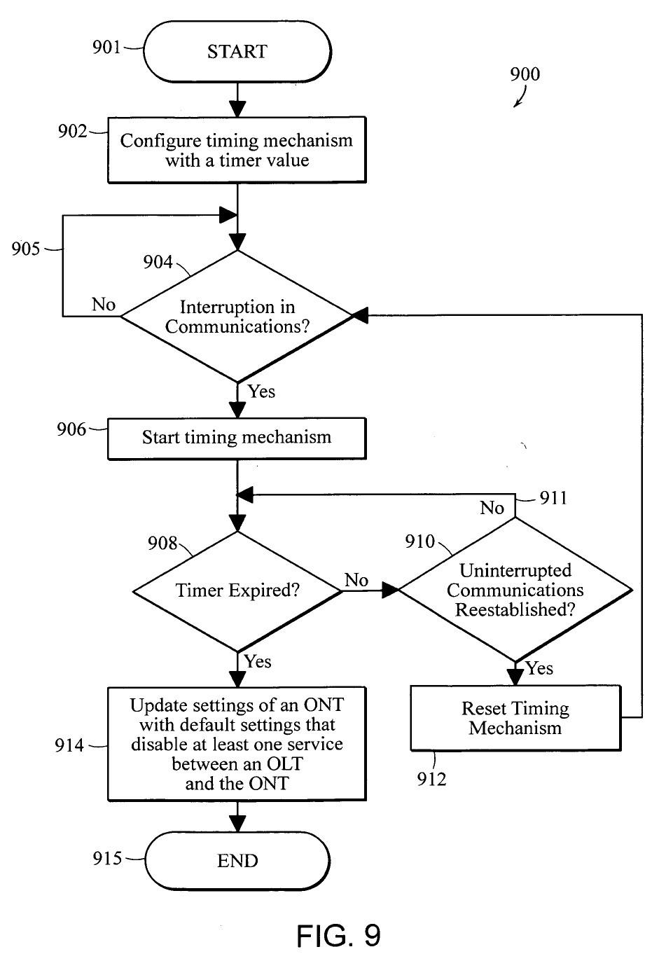

FIG. 9 is another example flow diagram 900 illustrating how an optical communications system may handle a situation in which an ONT is removed from a network without being properly deleted according to an embodiment of the present invention. After starting (901), a timing mechanism may be configured (902) with a timer value. The timer value may define a length of time from activating the timing mechanism to updating settings of the ONT. The length of time may be sufficient to allow an authorized person to remove the ONT from the network for a short time period. Next, the ONT monitors for an interruption in communications (904) indicating that the ONT has been disconnected from an OLT or a PON card. If there is an interruption in communications, the timing mechanism is started (906). Otherwise (905), the ONT continues to monitor for an interruption in communications (904). Next, the ONT monitors whether the timing mechanism has expired (908). If the timing mechanism has not expired, the ONT determines whether uninterrupted communications have been reestablished (910). If uninterrupted communications have been reestablished, the timing mechanism is reset (912) and the ONT returns to monitor for interruptions in communications (904).

If uninterrupted communications have not been reestablished (911), the ONT continues to monitor whether the timing mechanism has expired (908). The settings of the ONT are updated (914) with default settings that disable one or more communications services between an OLT and the ONT after the timing mechanism expires and before the flow diagram ends (915).

While this invention has been particularly shown and described with references to preferred embodiments thereof, it will be understood by those skilled in the art that various changes in form and details may be made therein without departing from the scope of the invention encompassed by the appended claims.

Although several embodiments are described in terms of optical elements, other embodiments may be applied to other networks, such as wired or wireless networks. For example, the OLT and ONTs may correspond to routers and servers in an electrical network.

It should be understood that removing an ONT from a network includes deleting an ONT record corresponding to the ONT, for example, from a management system, an OLT, or a PON card.

It should be also understood that elements of the block diagrams and flow diagrams described above may be implemented in software, hardware, or firmware. In addition, the elements of the block diagrams and flow diagrams described above may be combined or divided in any manner in software, hardware, or firmware. If implemented in software, the software may be written in any language that can support the embodiments disclosed herein. The software may be stored on any form of computer-readable medium, such as RAM, ROM, CD-ROM, and so forth. In operation, a general purpose or application specific processor loads and executes the software in a manner well understood in the art.

What is claimed is:

1. A method of updating settings of an Optical Network Terminal (ONT) with default settings, comprising:
notifying a management system that an ONT is removed from a network; and
updating settings of the ONT with default settings via an Optical Line Terminal (OLT) in operative communication with the management system, the default settings disabling at least one service between the OLT and the ONT.

2. The method according to claim 1 wherein updating settings of the ONT includes sending information to the ONT that causes the ONT to access a database containing the default settings and to update the settings of the ONT with the default settings.

3. The method according to claim 2 further comprising sending a message to the OLT indicating that the settings of the ONT have been updated with the default settings.

4. The method according to claim 1 further comprising accessing a database of the default settings, wherein updating settings of the given ONT includes provisioning the given ONT with the default settings.

5. The method according to claim 1 wherein notifying the management system that the ONT is removed from the network includes notifying the management system that the ONT is deleted from the network.

6. The method according to claim 1 wherein notifying the management system that the ONT is removed from the network includes notifying the management system that the ONT is removed from the network without being deleted.

7. The method according to claim 6 further comprising monitoring for a presence of the ONT at a different OLT or a different port at the same OLT, wherein updating settings of the ONT includes updating settings of the OLT with the default settings via the different OLT or the different port at the same OLT, the default settings disabling at least one service between the ONT and the different OLT or the different port at the same OLT.

8. The method according to claim 1 further comprising informing the OLT to delete the ONT from the network.

9. The method according to claim 1 further comprising deleting an ONT record from the OLT or the management system.

10. The method according to claim 1 further comprising discontinuing ranging of the ONT.

11. The method according to claim 1 wherein the at least one service includes data, voice, or video service.

12. An optical communications network with an Optical Line Terminal (OLT) and at least one Optical Network Terminal (ONT), comprising:
a notification unit configured to notify a management system that a given ONT is removed from a network; and
a default updating unit configured to update settings of the given ONT with default settings via an OLT to disable at least one service between the OLT and the given ONT.

13. The optical communications network according to claim 12 wherein the default updating unit sends information to the given ONT that causes the given ONT to access a database containing the default settings and to update its settings with the default settings.

14. The optical communications network according to claim 12 wherein the notification unit is configured to accept a message from the given ONT indicating that the settings of the given ONT have been updated with the default settings.

15. The optical communications network according to claim 12 wherein the default updating unit accesses a database containing the default settings and provisions the given ONT with the default settings.

16. The optical communications network according to claim 12 wherein the notification unit notifies the management system that the given ONT is deleted from the network.

17. The optical communications network according to claim 12 wherein the notification-unit notifies the management system that the given ONT is removed from the network without being deleted.

18. The optical communications network according to claim 17 further comprising:
at least one monitoring unit in operative communication with the management system configured to monitor for a presence of the given ONT at a different OLT or different port at the same OLT; and
a default updating unit at the different OLT or different port at the same OLT configured to update the settings of the given ONT with the default settings to disable at least one service between the given ONT and the different OLT or different port at the same OLT.

19. The optical communications network according to claim 12 wherein the management system notifies the OLT that the given ONT is removed from the network.

20. The optical communications network according to claim 12 further comprising a ranging unit in operative communication with the notification unit, the ranging unit configured to discontinue ranging the given ONT in response to the notification unit notifying it that the given ONT is removed from the network.

21. The optical communications network according to claim 12 wherein the at least one service includes data, voice, or video service.

22. A method of updating settings of an Optical Network Terminal (ONT) with default settings, the method comprising:
monitoring for an interruption in communications between an Optical Line Terminal (OLT) and an ONT;
activating a timing mechanism in response to the interruption in communications; and
updating settings of the ONT with default settings that disable at least one service between the OLT and the ONT after a length of time defined by the timing mechanism.

23. The optical communications network according to claim 22 further comprising configuring the timing mechanism with a timer value defining a length of time from activating the timing mechanism to updating settings of the ONT.

24. An optical communications network with an Optical Line Terminal (OLT) and at least one Optical Network Terminal (ONT), comprising:
a detector configured to detect an interruption in communications between an OLT and a given ONT;
a timing mechanism configured to be activated in response to detecting an interruption in communications; and
a default updating unit configured to update settings of the given ONT with default settings to disable at least one service between the OLT and the given ONT after a length of time defined by the timing mechanism.

25. The optical communications network according to claim 24 further comprising a database configured to store the default settings.

26. The optical communications network according to claim 24 wherein the timing mechanism is a configurable timing mechanism.
